(19) United States
(12) Patent Application Publication
(10) Pub. No.: US 2013/0181382 A1
(43) Pub. Date: Jul. 18, 2013

(54) Use of a Polyvinyl Alcohol Sheet in a Thermoforming Process for Manufacturing Containers

(71) Applicants: Saumitra Aich, Ludwigshafen (DE); Claudia Schmaelzle, Ludwigshafen (DE); Ralf Wiedemann, Mira (IT)

(72) Inventors: Saumitra Aich, Ludwigshafen (DE); Claudia Schmaelzle, Ludwigshafen (DE); Ralf Wiedemann, Mira (IT)

(73) Assignee: Reckitt Benckiser N.V., Hoofddorp (NL)

(21) Appl. No.: 12/740,276

(22) PCT Filed: Nov. 3, 2008
(86) PCT No.: PCT/GB2008/003710

§ 371 Date: Aug. 31, 2010

(30) Foreign Application Priority Data
Nov. 2, 2007 (GB) 0721568.4

(51) Int. Cl. B29C 51/10

(52) U.S. Cl. CPC B29C 51/10
USPC 264/571; 264/219; 264/320; 425/403

(57) ABSTRACT

Use of a poly(vinyl alcohol) sheet having either i) a thickness of at least 200 μm as a substrate having a reduced tendency to shrink back compared with the same poly(vinyl alcohol) sheet having a lesser thickness in a thermoforming process or ii) having a thickness of no more than 200 μm as a substrate in a vacuum forming process, to produce a pocket in a mould, wherein the mould comprises at least one protrusion or depression on at least one surface and further wherein any protrusion does not extend to or above the upper surface of the mould is provided. Also provided is process of producing a rigid pocket by a thermo-forming process or a non-rigid pocket by a vacuum-forming process.

The present invention relates to processes for preparing a container from a poly(vinyl alcohol) (PVOH) sheet.

It is known to package chemical compositions which may be of a hazardous or irritant nature in water-soluble or water-dispersible materials such as films. The package can simply be added to water in order to dissolve or disperse the contents of the package into the water. Such water-soluble containers may be formed by thermoforming a water-soluble material. In this regard reference is made to WO 92/17382 and WO 02/16205.

GB-A-2 405 828 and WO 2005/026016 disclose thermo-forming of PVOH containers having a thickness of at least 200 um to produce a pocket in a mould.

US 2005/0023718 discloses a method for moulding garments to provide fabric or material with a 3-D shape.

Moulding of thermoplastic material is known from e.g. JP 07223257 and JP 55150332. Vacuum forming is described in JP 03124560, JP 02102022 and JP 54114574.

WO 02/16205 discloses a process for preparing a water-soluble container from PVOH by thermoforming a PVOH film into a pocket, filling the pocket with a composition, placing a second film on top of the filled pocket and sealing the two films together. There is a major problem, however, in thermoforming PVOH. When thermoforming PVOH into a pocket the PVOH film is stretched; immediately after being thermoformed the PVOH film starts to shrink back away from the thermoforming mould. Even in the short time (around 1 to 15 seconds) before the pocket is filled on a commercial production line, the volume of the pocket can diminish by a significant amount, by up to 50%.

WO 04/003920 discloses the use of a poly(vinyl alcohol) (PVOH) sheet having a water content of at least 5 wt % and a thickness of at least 200 μm as a substrate having a reduced tendency to shrink back as compared to the same PVOH having a lower thickness in a thermoforming process to produce a pocket in a mould.

We have surprisingly discovered that PVOH can be thermoformed while minimising or avoiding this shrinkage and/or misshaping to provide containers having depressions or protrusions on at least one surface, even if standard PVOH is used. This is achieved in one of two ways; 1) if, instead of using a thin PVOH film in a thermoforming process, a thicker PVOH sheet is used, the shrinkage is reduced or even eliminated and the products so produced exhibit aesthetically pleasing contours or 2) if in a vacuum forming process a thin PVOH film is used the shrinkage still occurs to at least some extent but with retention of contours imparted to the film from the mould used to produce the container.

These contours may be used to produce different compartments or areas in the container to help separate different compositions as desired. Accordingly certain other advantages are realised in generating rigid containers, such as forming separate compartments and/or not needing to support the container fully during filling and sealing stages. Furthermore, the addition of these contours aids in the dissolution of the containers as the film thickness is reduced around them.

Accordingly, the first aspect of the present invention provides the use of a poly(vinyl alcohol) sheet having a thickness of at least 200 μm as a substrate having a reduced tendency to shrink back compared with the same poly(vinyl alcohol) sheet having a lesser thickness in a thermoforming process to produce a pocket in a mould, wherein the mould comprises at least one protrusion or depression on at least one surface thereof and further wherein any protrusion does not extend to, or above, the upper surface of the mould.

According to the first aspect of the invention it is preferred that the poly(vinyl alcohol) sheet has a thickness of 300 to 1000 μm.

The first aspect provides the advantage that if the sheet comprising PVOH (hereinafter PVOH sheet) has a thickness of at least 200 μm and the mould into which it is drawn has protrusions or depressions on at least one of its surfaces there is little or no shrinkage as compared with the same sheet comprising PVOH but having a lesser thickness, for example of 100 μm, and a container with aesthetically pleasing contours is formed which has good solubility characteristics. It is possible to fill the mould (pocket) to or near the brim without a substantial risk of overflow because the mould (pocket) does not substantially contract. The top sheet can then be placed on the PVOH sheet and sealed to it. Thus the pockets/containers can safely be filled to a greater extent than those described in WO 92/17382. This can in itself can impart a significantly more attractive appearance to the containers.

The pockets formed in this thermoforming process have the further advantage of being rigid after production and having good solubility as the PVOH sheet is thinned around the areas where is has been shaped to give contours by the presence of the depressions or protrusions in the mould. Rigid in the context of the present invention means that the pocket does not collapse under the load of a weight of specified mass. A pocket having the preferred size (see later) preferably collapses no more than 80% by height, preferably no more than 60% by height and most preferably no more than 40% by height when a 100 g weight (having suitable dimensions of 50×50×50 mm) is placed on the closed side of the pocket, the open side of the pocked being place on a support.

The rigidity allows patterns and/or a relief to be formed on the pocket. In this way it is possible, for example, to form protruding embossed letters on the pocket. Additionally cavities can be formed in the pocket, into which a filling composition can be filled or glued. It has also been found that if using thin PVOH sheets for vacuum forming that the material shrinks after being removed from the mould but that contours imparted to the mould are retained.

The rigid sheets for use in the thermoforming process are preferably made in an extrusion method, such as by die cast extrusion or calendering. In this way it has been found that a pocket with especially high rigidity can be produced. Thus according to the first aspect of the invention there is provided a process for the manufacture of a rigid pocket from a rigid sheet, wherein the process comprises forming the rigid sheet in an thermo-shaping process and thermoforming the sheet into a rigid pocket in a mould having depressions or protrusions on at least one surface thereof.

The sheet used in the thermoforming process preferably has a certain stiffness. Stiffness in this context means that a strip of material having the dimensions of 10×100 mm when placed with half its length on a horizontal support should bend no more than 70°, preferably no more than 50° and most preferably no more than 30° when a weight is placed on its non-supported end. The angle is measured between the horizontal plane and the line defined by the end on the horizontal support of the strip and the edge of the free standing strip.

We have also surprisingly discovered that if a non-rigid, thin, PVOH film is used in a vacuum forming process with a mould having depressions or protrusions on at least on one surface of the mould, the non-rigid, thin, PVOH film forms around the depressions or protrusions upon application of the vacuum to form temporary pockets and a solid, a liquid or a gel composition can be positioned during the vacuum forming process. After releasing the vacuum-formed container from the mould, the non-rigid thin PVOH film shrinks back, but the positioned solids, liquids or gels in their positions in the container and the depressions or protrusions are not visible in the container after the vacuum process has finished.

According to a second aspect the present invention provides the use of a poly(vinyl alcohol) sheet having a thickness of no more than 200 μm as a substrate in a vacuum forming process to produce a pocket in a mould, wherein the mould comprises at least one protrusion or depression on at least one surface thereof and further wherein any protrusion does not extend to or above the upper surface of the mould.

According to a third aspect the present invention provides a process for the manufacture of a rigid pocket from a rigid sheet, wherein the process comprises forming the rigid sheet in a thermo-shaping process and thermoforming the sheet into a rigid pocket in a mould having depressions or protrusions on at least one surface thereof and further wherein any protrusion does not extend to or above the upper surface of the mould.

According to a fourth aspect the present invention provides a process for the manufacture of a pocket from a non-rigid sheet, wherein the process comprises forming the non-rigid sheet in a thermo-shaping process and vacuum forming the non-rigid sheet into a non-rigid pocket in a mould having depressions or protrusions on at least one surface thereof and further wherein any protrusion does not extend to or above the upper surface of the mould.

According to the second and forth aspect of the invention the poly(vinyl alcohol) sheet preferably has a thickness of no more than 200 um, more preferably no more than 150 μm, more preferably no more than 100 um. The sheets are preferably flexible.

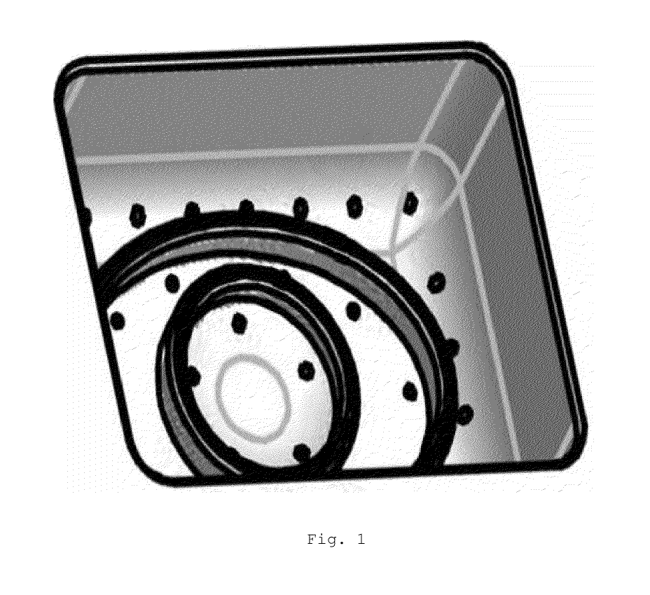

For the avoidance of doubt the protrusions may extend from the base face and/or one or more side walls of the mould into the cavity formed by the base wall and the four side walls. Thus the protrusion extends above the face on which it is located and into the internal cavity of the mould. The mould also has an open face which is generally opposed to the base face. A depression in the mould extends from the base face and/or side wall(s) away from the mould cavity and thus extends below or beyond the mould cavity. Thus a protrusion in one or more faces of the mould produces a depression extending into the body of the moulded article. Also a depression in one or more faces of the mould produces a protrusion extending away from the body of the moulded article. This can be seen from FIG. 1.

The PVOH sheet may be partially or fully alcoholised or hydrolysed, for example, it may be from 40 to 100%, preferably 70 to 92%, most preferably about 88% or about 92%, alcoholised or hydrolysed, polyvinyl acetate sheet. The degree of hydrolysis is known to influence the temperature at which the PVOH starts to dissolve in water. 88% hydrolysis corresponds to a sheet soluble in cold (i.e. room temperature) water, whereas 92% hydrolysis corresponds to a sheet soluble in warm water. The sheet is preferably water-soluble at room temperature (20° C.), but alternatively it may be insoluble in cold water at 20° C. and only become soluble in warm water or hot water having a temperature of, for example, 30° C., 40° C., 50° C. or even 60° C. An example of a preferred PVOH is an esterified or etherified PVOH.

The sheet preferably comprises PVOH (as described above). Suitable PVOH resin grades (for both aspects of the invention) are available from e.g. Kuraray, Panteco, Celanese.

After the pocket has been produced in either the thermoforming process using ‘thick/rigid’ sheets, or, in the vacuum forming process using ‘soft’ sheets it can be further processed as desired. For example, preferably the pocket may be filled with a composition, a top film placed on top of the filled pocket, and the PVOH sheet and the top film sealed together to form a container containing the composition. The closing of the pocket may alternatively be achieved by casting a solidifying portion (such as a wax) onto the filling composition.

It is possible for suitable additives such as plasticisers, lubricants and colouring agents to be added to the PVOH sheet used in both the thermo-forming and vacuum processes of the invention. Components which modify the properties of the polymer may also be added. Plasticisers are generally used in an amount of up to 35 wt %, for example from 5 to 35 wt %, preferably from 7 to 20 wt %, more preferably from 10 to 15 wt %. Lubricants are generally used in an amount of 0.5 to 5 wt %. The polymer is therefore generally used in an amount of from 60 to 94.5 wt %, based on the total amount of the composition used to form the sheet. Suitable plasticisers are, for example, pentaerythritols such as depentaerythritol, sorbitol, mannitol, glycerine and glycols such as glycerol, ethylene glycol and polyethylene glycol. Solids such as talc, stearic acid, magnesium stearate, silicon dioxide, zinc stearate or colloidal silica may also be used.

It is also possible to include one or more particulate solids in the PVOH sheet in order to accelerate the rate of dissolution of the sheet or container made from it. This solid may also be present in the contents of the container. Dissolution of the solid in water is sufficient to cause an acceleration in the break-up of the container, particularly if a gas is generated, when the physical agitation caused may, for example, result in the virtually immediate release of the contents from the container. Examples of such solids are alkali or alkaline earth metal, such as sodium, potassium, magnesium or calcium, bicarbonate or carbonate, in conjunction with an acid. Suitable acids are, for example, acidic substances having carboxylic or sulfonic acid groups or salts thereof. Examples are cinnamic, tartaric, mandelic, fumaric, maleic, malic, palmoic, citric and naphthalene disulfonic acids.

It is particularly important to avoid pinholes in the sheet through which leakage of the contained composition may occur, especially when a thinner sheet is used in vacuum forming than is used in thermo-forming. Bearing in mind that a relatively thick sheet is used in thermo-forming, pinholes are unlikely to occur. It may, however, be appropriate to use a laminate of two or more layers of a different or the same sheet, as pinholes are unlikely to coincide in two layers of material.

The method of forming the container from rigid/thick PVOH sheets by thermoforming may be similar to methods previously described in this document or similar to the method described in WO 92/17382 and WO 02/16205 except for using a PVOH sheet having a thickness of at least 200 μm. The first PVOH sheet is initially thermoformed to produce a non-planar sheet containing a pocket, such as a recess, which is able to retain the composition. The pocket is generally bounded by a flange, which is preferably substantially planar. The pocket may have internal barrier layers as described in, for example, WO 93/08095.

A preferred thermoforming process is drape forming. In drape forming a heated clamped sheet is either lowered onto a cool male mould or a cool male mould is raised into the sheet. The sheet that is in contact with the mould does not stretch. The mould penetrates and stretches remainder of the sheet. In the stretching process any air trapped between the sheet and the mould is evacuated.

Items produced by drape forming typically have a thick bottom wall and thin side walls. The formed is thinnest at the rim.

Another preferred thermoforming process is vacuum forming and this has been found to be especially suitable according to the present invention for soft/flexible PVOH sheets according to the second and fourth aspects of the present invention. It can also be used with the thick/rigid PVOH sheets. In vacuum forming a clamped heated sheet is sealed against the rim of a cool female mould. Vacuum is applied from underneath the mould, drawing the sheet against the mould surface. This technique is sometimes referred to as cavity forming.

Items produced by this technique have a thick rim and are thinnest in the bottom corners.

A further preferred thermoforming process is the matched die moulding process. In this process a clamped sheet is positioned between two matched mould halves. Optionally vacuum can be applied to the closing moulds to assist in forming. The thickness of items produced by this technique depends upon the mating tolerance of the two mould halves. Normal operating pressures for this technique are between 50 psi and 150 psi.

The thermo-forming and vacuum processes described herein are especially suitable for the making of multi compartment pockets. It is also especially suitable to create pockets with patterns.

Also multiple step thermoforming processes can be applied in the formation of pockets. Several multiple step techniques can be used; such as billow drape forming, vacuum snap back forming, billow vacuum forming, plug assist vacuum forming, plug assist pressure forming, reverse draw with plug assist, vacuum reverse draw with plug assist and pressure bubble immersion forming.

In vacuum snap back forming a softened sheet is drawn down by vacuum into an expansion box below a male mould to pre-stretch the film. The mould is then lowered into the expansion box and the vacuum is released/reversed causing the sheet to spring back on to the mould. This method is applicable to all aspects of the present invention.

In billow vacuum forming a softened sheet is first blown upwards away from a female mould into a free form bubble. A vacuum is applied to sucks the bubble down into the female mould. This results in the vacuum formed items having a much more uniform thickness and is preferred in deep draw applications to avoid thin corners. This method is applicable to all aspects of the present invention.

In plug assist vacuum forming a softened sheet is pre-stretched by pushing it down into a female mould mechanically using a driven plug. Vacuum is applied to pull the film against the mould surface. The technique is preferred for multiple cavity thin gauge forming where control of wall thickness is required. The technique can produce deep draw, uniform thickness, thin bottom or thick bottom items. This method is applicable to all aspects of the present invention.

Also technologies like solid phase pressure forming (SPPF), steam thermoforming or reinforced sheet thermoforming can be used as appropriate.

The pocket is then filled with the composition. Unlike the process described in WO 92/17382, the pocket does not have to be immediately filled for the thick/rigid PVOH sheet. Since the thermoformed thick sheet has a degree of shape and size stability it does not immediately shrink. Once it has been filled with the composition, a top film, preferably a PVOH film, is placed on the flange and across the pocket.

The top film may or may not be thermoformed. If the PVOH sheet contains more than one pocket, the top film may be placed across all of the pockets for convenience.

The pocket is desirably completely filled so that the filled containers look full. However, it is possible, for example, to leave an airspace of from 2 to 20%, especially from 5 to 10%, of the volume of the container immediately after it is formed. Partial filling may reduce the risk of rupture of the container if it is subjected to shock and may reduce the risk of leakage if the container is subjected to high temperatures.

The top film may be made of any material. Desirably it is also water-soluble at room temperature. More desirably it is a PVOH top film. The PVOH may be the same or different PVOH from that making up the PVOH sheet. It is preferred that the container is soluble in water at 20° C.

The top film may be chosen, if desired, such that it has the same thickness as the PVOH sheet after the PVOH sheet has been thermoformed (including vacuum forming) in order to provide a composition which is encapsulated by a substantially constant thickness of sheet.

Due to the high rigidity of the pocket obtained in the thermoforming process according to the first/third aspect of the invention by the use of the thick/rigid PVOH the attachment of a sealing lid has been found to proceed efficiently with the provision of an effective seal. The lid may be glued to the pocket, sealed to the pocket or mechanically adhered to the pocket. The lid may be joined to the pocket with a hinge before.

The PVOH sheet and the top film may be sealed together by heat sealing across the flange. A suitable heat sealing temperature is, for example, 120 to 195° C., for example 140 to 150° C. A suitable sealing pressure is, for example, from 250 to 800 kPa. Examples of sealing pressures are 276 to 552 kPa (40 to 80 p.s.i.), especially 345 to 483 kPa (50 to 70 p.s.i.) or 400 to 800 kPa (4 to 8 bar), especially 500 to 700 kPa (5 to 7 bar) depending on the heat sealing machine used. Suitable sealing dwell times are at least 0.4 seconds, for example 0.4 to 2.5 seconds.

Other methods of sealing the films together may be used, for example infra-red, radio frequency, ultrasonic, laser, solvent, vibration, electromagnetic, hot gas, hot plate, insert bonding, fraction sealing or spin welding. An adhesive such as water or an aqueous solution of PVOH may also be used. The adhesive can be applied to the sheets by spraying, transfer coating, roller coating or otherwise coating, or the sheets can be passed through a mist of the adhesive. The seal desirably is water-soluble if the container itself is to be water-soluble.

During the thermoforming process (including vacuum forming) the PVOH will be subjected to localised stretching depending on the shape of the mould. Accordingly parts of the thermoformed PVOH sheet will have a thickness of less than the thickness of the sheet before it was thermoformed. Thus the rigid/think parts of the sheets after thermoforming may have a thickness of as little as 20 or 40 μm. The thickness of the top film is desirably less than that of the PVOH sheet as the top film will not generally be thermoformed, so localised thinning of the film will not occur. The thickness of the top film will generally be from 20 to 150 or 160 μm, preferably from 40 or 50 to 90 or 100 μm, more preferably from 50 to 80 μm. However a top film having a thickness of 70 to 150 μm may also be used.

The nature of the filling composition is not limited. It may, for example, be a solid or a liquid. If it is in the form of a solid it may, for example, be in the form of a powder, granules, an extruded tablet, a compressed tablet, a melt or a solidified gel. If it is in the form of a liquid it may be optionally thickened or gelled with a thickener or a gelling agent. One or more than one phase may be present.

For example the pocket may be filled with a liquid composition and a separate solid composition, for example in the form of a ball, pill or speckles. Alternatively two or more solid phases may be present, or two or more immiscible liquid phases.

Thus the composition need not be uniform. For example, during the manufacture the pocket could first be filled with a settable composition, for example a gel, and then with a different composition such as a liquid, especially an aqueous, composition. The first composition could dissolve slowly, for example in a washing process, so as to deliver its charge over a long period. This might be useful, for example, to provide an immediate, delayed or sustained delivery of a component such as a softening agent.

In a particular preferred embodiment of the invention according to any aspect the pocket may be portioned, for example by a dividing wall, into a plurality of separate portions. Each portion may be filled with the same different filling compositions. Such a product could for example be a two compartment product whereby one portion may be filled with a liquid composition and a second portion may be filled with a solid composition. After filling, both pockets could be sealed with a film.

If the water-soluble pocket/container is soluble in cold water at room temperature (20° C.) or slightly above, it is important to ensure that the composition itself does not dissolve the pocket. In general solid compositions will not attack the pocket, and neither will liquid organic compositions which contain less than around 5 wt % of water, as described, for example, in WO 92/17382. If the composition is in the form of a liquid containing more than about 5 wt % water, action must be taken to ensure that the composition does not attack the walls of the pocket. Steps may be taken to treat the inside surface of the pocket, for example by coating it with an agent such as PVdC (poly(vinylidene dichloride)) or PTFE (polytetrafluoroethylene). A semi-permeable or partial water barrier such as polyethylene or polypropylene or a hydrogel such as a polyacrylate may also be provided as a coating. The coating will simply fall apart or dissolve or disperse into microscopic particles when the pocket is dissolved in water. Steps may also be taken to adapt the composition to ensure that it does not dissolve the pocket.

For example, it has been found that ensuring the composition has a high ionic strength or contains an agent which minimises water loss through the walls of the pocket will prevent the composition from dissolving a PVOH sheet from the inside. This is described in more detail in EP-A-518,689 and WO 97/27743.

The total amount of water in the composition may be more than 5 wt %, for example more than 10, 15, 20, 25 or 30 wt %. The total water content may be less than 80 wt % for example less than 70, 60, 50 or 40 wt %. It may, for example, contain from 30 to 65 wt % total water.

If more than one container is formed at the same time, the packaged compositions may then be separated from each other. Alternatively, they may be left conjoined and, for example, perforations provided between the individual containers so that they can be easily separated at a later stage, for example by a consumer.

If the containers are separated, the flanges may be left in place. However, desirably the flanges are partially removed in order to provide an even more attractive, three-dimensional appearance. Generally the flange remaining should be as small as possible for aesthetic purposes while bearing in mind that some flange is required to ensure the two films remain adhered to each other. A flange of 1 mm to 10 mm is desirable, preferably 2 mm to 7 mm, more preferably 4 mm to 6 mm, most preferably about 5 mm. It has been found that in some aspects of the invention a flange of 1 to 3 mm is preferably such as about 2 mm.

The containers may themselves be packaged in outer containers if desired, for example non-water soluble containers which are removed before the water soluble containers are used.

The containers of the present invention generally contain from 5 to 100 g of composition, such as an aqueous composition, especially from 15 to 40 g, depending on their intended use. For example, a dishwashing composition may weigh from 15 to 30 g, a water-softening composition may weigh from 15 to 30 g, and a laundry composition may weigh from 20 to 50 g, especially 20 to 30 g or 30 to 40 g.

The containers may have any shape and the contours produced on them by the depressions and/or protrusions on at least one surface of the mould may also take any form. For example the containers can take the form of an envelope, sachet, sphere, cylinder, cube or cuboid, i.e. a rectangular parallelepiped whose faces are not all equal. If the container is formed from a thermoformed film and a planar film, the seam between the two films will appear nearer one face of the container rather than the other. The contours on the surface of the container, produced by the mould, may be of a regular or irregular shape etc. Preferably the contours on the surface of the container are produced by protrusions or depressions on the opposite face of the mould to the mould cavity.

In general the maximum dimension of the filled part of the container (excluding any flanges) is 5 cm. For example, a rounded cuboid container may have a length of 1 to 5 cm, especially 3.5 to 4.5 cm, a width of 1.5 to 3.5 cm, especially 2 to 3 cm, and a height of 1 to 2.5 cm, especially 1 to 2 cm, for example 1.25 to 1.75 cm.

The composition filling the pockets/containers is not particularly limited. It can be any composition which is to be added to an aqueous system or used in an aqueous environment. Desirably the composition is a fabric care, surface care or dishwashing composition. For example, the composition may comprise a dishwashing, water-softening, laundry or detergent composition or a rinse aid. In this case it is especially suitable for use in a domestic washing machine such as a laundry washing machine or dishwashing machine. The container may also comprise a disinfectant, antibacterial or antiseptic composition intended to be diluted with water before use, or a concentrated refill composition, for example for a trigger-type spray used in domestic situations. Such a composition can simply be added to water already held in the spray container.

Examples of surface care compositions are those used to clean, treat or polish a surface. Suitable surfaces are, for example, household surfaces such as worktops, as well as surfaces of sanitary ware, such as sinks, basins and lavatories.

The ingredients of the composition depend on the use of the composition. Thus, for example, the compositions may contain surface active agents such as anionic, nonionic, cationic, amphoteric or zwitterionic surface active agents or mixtures thereof.

In laundry applications anionic surfactants are preferred.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:

ROSO₃⁻M⁺

wherein R is a linear C₈-C₂₀ hydrocarbyl group and M is a water-solubilising cation. Preferably R is C₁₀-C₁₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:

CH₂(CH₂)ₙ(CHOSO₃⁻M⁺)(CH₂)ₘCH₃

wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:

CH₂(CH₂)ₓ(CHOSO₃⁻M⁺)CH₃

and

CH₃(CH₂)ₓ(CHOSO₃⁻M⁺)CH₂CH₃

for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:

RO(C₂H₄O)ₙSO₃⁻M⁺

wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium, potassium or alkanolammonium salts, and alkyl, for example C₈-C₁₈, benzene sulfonates.

In automatic dishwashing applications non-ionic surfactants are preferred especially those which have low foaming characteristics.

Examples of nonionic surfactants are fatty acid/fatty alcohol alkoxylates, such as fatty acid ethoxylates, especially those of formula:

R(C₂H₄O)ₙOH

wherein R is a straight or branched C₈-C₁₆ alkyl group, preferably a C₉-C₁₅, for example C₁₀-C₁₄ or C₁₂-C₁₄, alkyl group and n is at least 1, for example from 1 to 16, preferably 2 to 12, more preferably 3 to 10.

The alkoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁ primary alcohol having about 10 moles of ethylene oxide.

Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated C₁₂-C₁₅ fatty alcohol with an average of 7 moles of ethylene oxide per mole of fatty alcohol.

Other examples of suitable ethoxylated alcohol nonionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated nonionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further nonionic surfactants are, for example, C₁₀-C₁₈ alkyl polyglycosides, such as C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type.

Examples of amphoteric surfactants are C₁₀-C₁₈ amine oxides and the C₁₂-C₁₈ betaines and sulfobetaines.

The total content of surfactants in a laundry or detergent composition is desirably 20 to 95 wt %, especially 30 to 90 wt %. Desirably, especially in a laundry composition, an anionic surfactant is present in an amount of 50 to 75 wt %, a nonionic surfactant is present in an amount of 5 to 20 wt %, a cationic surfactant is present in an amount of from 0 to 10 wt % and/or an amphoteric surfactant is present in an amount of from 0 to 10 wt %. Desirably in an automatic dishwashing composition, the anionic surfactant is present in an amount of from 0.1 to 5%, a non-ionic surfactant is present in an amount of 0.5 to 20 wt % and/or a cationic surfactant is present in an amount of from 0.1 to 5 wt %. These amounts are based on the total solids content of the composition, i.e. excluding any water which may be present.

Automatic dishwashing compositions and also laundry compositions usually comprise a detergency builder.

Suitable builders are alkali metal or ammonium phosphates, polyphosphates, phosphonates, polyphosphonates, carbonates, bicarbonates, borates, polyhydroxysulfonates, polyacetates, carboxylates and polycarboxylates such as citrates. The builder is desirably present in an amount of up to 90 wt % preferably 15 to 90 wt %. More preferably 15 to 75 wt %, relative to the total content of the composition. Further details of suitable components are given in, for example, EP-A-694,059, EP-A-518,720 and WO 99/06522.

The compositions, particularly when used as automatic dishwashing/laundry washing compositions, may also comprise enzymes, such as protease, lipase, amylase, cellulase and peroxidase enzymes. Such enzymes are commercially available and sold, for example, under the registered trade marks Esperase, Alcalase, Savinase, Termamyl, Lipolase and Celluzyme by Novozymes. Desirably the enzymes are present in the composition in an amount of from 0.05 to 3 wt %, especially 0.1 to 2 wt % based on the weight of active.

The compositions may, if desired, comprise a thickening agent or gelling agent. Suitable thickeners are polyacrylate polymers such as those sold under the trade mark CARBOPOL, or the trade mark ACUSOL by Rohm and Haas

Company. Other suitable thickeners are xanthan gums. The thickener, if present, is generally present in an amount of from 0.2 to 4 wt %, especially 0.5 to 2 wt %.

The compositions can also optionally comprise one or more additional ingredients. These include conventional detergent composition components such as further surfactants, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, phosphates such as sodium tripolyphosphate or potassium tripolyphosphate, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners and perfumes. If used, such optional ingredients will generally constitute no more than 10 wt %, for example from 1 to 6 wt %, of the total weight of the compositions.

The builders counteract the effects of calcium, or other ion, water hardness encountered during laundering or bleaching use of the compositions herein. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred.

Other suitable co-builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan. Co-builders may be used in amount up to 30% of the composition.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt % of the compositions.

The compositions may optionally comprise materials which serve as phase stabilizers and/or co-solvents. Example are C₁-C₃ alcohols or diols such as methanol, ethanol, propanol and 1,2-propanediol. C₁-C₃ alkanolamines such as mono-, di- and triethanolamines and monoisopropanolamine can also be used, by themselves or in combination with the alcohols. The phase stabilizers and for co-solvents can, for example, constitute 0.1 to 1 wt %, preferably 0.1 to 0.5 wt %, of the composition.

If the composition is in liquid form, it may be anhydrous, or, for example, contain up to 5 wt % water. Aqueous compositions generally contain greater than 8 wt % water based on the weight of the aqueous composition. Desirably the aqueous compositions contain more than 10 wt %, 15 wt %, 20 wt %, 25 wt % or 30 wt % water, but desirably less than 80 wt % water, more desirably less than 70 wt %, 60 wt %, 50 wt % or 40 wt % water. They may, for example, contain from 30 to 55 or 65 wt % water.

The compositions may optionally comprise components which adjust or maintain the pH of the compositions at optimum levels. Examples of pH adjusting agents are NaOH and citric acid. The pH may be from, for example, 1 to 13, such as 8 to 11 depending on the nature of the composition. For example, a dishwashing composition desirably has a pH of 8 to 11, a laundry composition desirably has a pH of 7 to 9, and a water-softening composition desirably has a pH of 7 to 9.

The composition may, for example, comprise a component which releases a gas after the container has been sealed which inflates the container to make it look more attractive to a consumer. This component may, for example, comprise a component or a mixture of two or more components which react in the presence of the contents of the container to release the gas. For example, when water is present in the composition, two components which do not react when in solid form but which will react in the presence of water can be added, such as an acid and a carbonate or bicarbonate. An example of a suitable acid is citric acid. Examples of suitable carbonates and bicarbonates are sodium and potassium carbonate and sodium and potassium bicarbonate. If desired, one or more of the components may be encapsulated by a substance which delays the release of the gas.

A further possibility is a component which is a gas at room temperature (20° C.) but which, at the time which it is added, is in the form of a solid or liquid because it has been cooled to lessen its melting or boiling point. For example, solid carbon dioxide (dry ice) may be added. As the component heats up to room temperature, which may occur naturally or be aided with heating, it will boil or sublime into a gas. Another possibility is to add a compound which is thermally unstable; for example sodium bicarbonate will release carbon dioxide when it is heated to about 60° C.

The component which releases a gas may also, for example, be a component which gradually releases a gas such as a bleach, in particular an oxygen bleach or a chlorine bleach. Such a bleach will gradually release a gas such as oxygen or chlorine when it contacts water. Any type of bleaching compound conventionally used in detergent compositions may be used according to the present invention. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate. Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP) and sodium percarbonate.

The water may itself be contained in the composition, be contained in another compartment and diffuse through the dividing wall into the compartment holding the bleach, or may diffuse into the composition from outside the container.

The gas which is released should desirably be non-toxic or produced in small quantities. It is most convenient, however, to produce carbon dioxide gas since this will not cause any environmental concerns.

The present invention will now be further described with reference to the following non-limiting Examples.

### EXAMPLES

### Example 1

According to the first aspect of the invention, pellets of PVOH (F7 available from Panteco) are extruded and film cast using a flat die extrusion equipment combined with a chilled roll calendering unit (single screw extruder Plasti-Corder from Brabender).

The extruder has the following properties:
Screw diameter: 19 mm.
Length: 25 cm
Geometry: Cone-shaped
Die: Flat, web width 10 cm, the opening of die orifice 1 mm.

Temperature settings of the extruder:

Feed section: 150° C.

Compression section: 200° C.

Metering section: 195° C.

Die: 170° C.

Screw rate: 144 turns/min

Opening of Die Orifice: 1 mm

Different thicknesses of sheets are produced by changing the extent of stretch (roll speed).

Samples of different thickness are cast as follows:

| Thickness | Roller speed |
|---|---|
| 1000 micron | 0.6 m/min |
| 800 micron | 0.8 m/min |
| 700 micron | 1.0 m/min |
| 600 micron | 1.2 m/min |
| 500 micron | 1.4 m/min |
| 400 micron | 1.6 m/min |

The films were allowed to chill to room temperature and the bending angles were measured 1 hour after production. All thicknesses had bending angles of less than 50°.

A 500 microns thick film is thermoformed on a Tommy Nielsen thermoformer having cavity dimensions of 18 mm×length 45 mm×width 35 mm and one protrusion from the bottom surface of the cavity which protrudes upwards and lengthways from the surface to produce a depression in the rigid pocket when formed (180° C. thermoforming temperature, 10 sec of contact time of sheet to heating unit, 10 sec as forming time, vacuum was at 0.3 bar, air pressure from top was 1.5 bar). Rigid pockets were formed comprising a depression running across their width.

### Example 2

Also according to the first aspect of the invention, pellets of PVOH (Mowiol grades in the range of 3-85 to 26-88, available from Kuraray), plasticiser, and optionally glycerine in an amount of from 5-15% wt, and minor amounts of processing aids are extruded and film cast using a flat die extrusion equipment combined with a chilled roll calendering unit (single screw extruder Plasti-Corder from Brabender).

The extruder has the following properties:
Screw diameter: 19 mm.
Length: 25 cm
Geometry: Cone-shaped
Die: Flat, web width 10 cm, the opening of die orifice 1 mm.

Temperature settings of the extruder:

Feed section: 150° C.

Compression section: 200° C.

Metering section: 195° C.

Die: 170° C.

Screw rate: 144 turns/min

Opening of Die Orifice: 1 mm

Different thicknesses of sheets are produced by changing the extent of stretch (roll speed). Samples of different thickness are cast as follows:

| Thickness | Roller speed |
|---|---|
| 1000 micron | 0.6 m/min |
| 800 micron | 0.8 m/min |
| 700 micron | 1.0 m/min |
| 600 micron | 1.2 m/min |
| 500 micron | 1.4 m/min |
| 400 micron | 1.6 m/min |

The films were allowed to chill to room temperature and the bending angles were measured 1 hour after production. All thicknesses had bending angles of less than 50°.

A 500 microns thick film is thermoformed on a Tommy Nielsen thermoformer having cavity dimensions of 18 mm depth, 45 mm length and 35 mm width and having an inner circular protrusion of diameter of 1.5 mm in the middle of the bottom face of the cavity (opposite the open face of the cavity) and an outer oval-shaped protrusion surrounding the inner circular protrusion as shown in FIG. 1 to produce a depression in the corresponding face of the rigid pocket when formed. FIG. 1 shows the top open face of the mould and the base face thereof with projections rising up from the base face towards the open face which is defined by the top of the four side walls. The projections in the base face of the mould produce depressions in the corresponding face of the pocket/container which is in contact therewith.

The pocket is produced by thermo-forming using the following conditions;
180° C. thermoforming temperature,
second contact time of rigid sheet to heating unit,
second forming time in the mould,
vacuum was applied at 0.3 bar,
air pressure from the top was 1.5 bar.

Rigid pockets were formed comprising a depression running across the width of the face in contact with the lower face of the mould.

The outer oval shaped depression (with the inner circular depression contained within it) may be filled with any suitable composition such as a liquid gelatine-water mixture (10% gelatine in deionised water, heated up to 70° C.). After 3 minutes the gel set. The inner circular depression may be filled with any suitable composition but is preferably also filled with a composition which sets or with a solid or semi-solid composition. Typically a solid composition (such as a phosphorus-containing or a phosphorus-free powder as given in Table 1) is added to the rigid pocket to a level about 1 mm below the upper rim of the side walls of the pocket. The pocket is then sealed with a top film (commercially available PVOH film, thickness 90 μm, sealing temperature 170° C., 10 sec sealing time). After releasing the container from the mould a rigid container is obtained with an oval shaped ring of gel on the front. The inner circular part may also be filled with the same composition e.g. powder as added to the rest of the pocket.

TABLE 1
powder composition

| | Phosphorus- | | Phosphorus- | |
|---|---|---|---|---|
| | Containing | | free | |
| Raw Material | % wt | | % wt | |
| Sodium Tripolyphosphate | 50 | | 0 | |
| Trisodium citrate | 0 | | 50 | |
| Sodium Percarbonate | 15 | | 15 | |
| Sodium Carbonate | 19.4 | | 19.4 | |
| TAED | 5 | | 5 | |
| Protease | 1.5 | | 1.5 | |
| Amylase | 1 | | 1 | |
| Corrosion Inhibitor | 0.1 | | 0.1 | |
| Sulfonated Polymer | 5 | | 5 | |
| Nonionic Surfactant | 3 | | 3 | |
| | 100% | wt | 100% | wt |

### Example 3

According to the second aspect of the invention a commercially available PVOH film of thickness 90 μm is vacuum formed on a Tommy Nielson Thermoformer having cavity dimensions of 18 mm depth, 45 mm length and 35 mm width and having an inner circular protrusion of diameter of 1.5 mm in the middle of the bottom face of the cavity (opposite the open face of the cavity) and an outer oval-shaped protrusion surrounding the inner circular protrusion as shown in FIG. 1 to produce a depression in the corresponding face of the rigid pocket when formed.

The pocket is produced by vacuum-forming using the following conditions;
150° C.,
second contact time of rigid sheet to heating unit,
second forming time in the mould,
vacuum was applied at 0.3 bar,
air pressure from the top was 1.5 bar.

The film forms around the protrusions in the base of the mould to form the pocket. The pocket is filled in the same manner as for Example 2. The film forming the pocket shrinks immediately and a pouch-like product (pocket) with an even surface and a centrally positioned oval shaped gel ring is obtained.

1. A method for forming a mould comprising at least one protrusion or depression on at least one surface and further wherein any protrusion does not extend to or above an upper surface of the mould, the method comprising the step of:
forming a pocket of a poly(vinyl alcohol) sheet having a thickness of at least 200 μm as a substrate having a reduced tendency to shrink back compared with the same poly(vinyl alcohol) sheet having a lesser thickness by a thermoforming process to produce said pocket in the mould.

2. A method according to claim 1, wherein the poly(vinyl alcohol) sheet has a thickness of 300 to 1000 μm.

3. A method for forming a pocket in a mould, wherein the mould comprises at least one protrusion or depression on at least one surface thereof and further wherein any protrusion does not extend to or above the upper surface of the mould comprising the step of:
vacuum forming said pocket of a poly(vinyl alcohol) sheet having a thickness of no more than 200 μM as a substrate in a vacuum forming process to produce a pocket in the mould.

4. A method according to claim 1, wherein the poly(vinyl alcohol) sheet is soluble in water at a temperature of 20° C.

5. A method according to claim 1, wherein the method comprises the further steps of;
filling the pocket with a composition, and thereafter placing a top film on top of the filled pocket, and subsequently sealing together the top film and the poly(vinyl alcohol) sheet to form a container containing the composition.

6. A method according to claim 1, wherein the pocket is divided into a plurality of separate portions.

7. A method according to claim 1, wherein the container is at least partially formed using a material which is soluble in water at a temperature of 20° C.

8. A method according to claim 1, wherein the composition is a liquid or particulate composition.

9. A method according to claim 5, wherein the composition is a fabric care, surface care or dishwashing composition.

10. A process for the manufacture of a rigid pocket from a rigid sheet, wherein the process comprises the steps of:
forming the rigid sheet in a thermo-shaping process and thermoforming the sheet into a rigid pocket in a mould having depressions or protrusions on at least one surface thereof and further wherein any protrusion does not extend to or above the upper surface of the mould.

11. A process according to claim 10, wherein the thermo-shaping process comprises calendering or die casting.

12. A process according to claim 11, wherein the sheet has a thickness of 300 to 1000 μm.

13. A process for the manufacture of a pocket from a non-rigid sheet, wherein the process comprises the steps of:
forming the non-rigid sheet in a thermo-shaping process and vacuum forming the non-rigid sheet into a non-rigid pocket in a mould having depressions or protrusions on at least one surface thereof and further wherein any protrusion does not extend to or above the upper surface of the mould.

14. A process according to claim 13, wherein the sheet has a thickness of no more than 200 μm.

15. A process according to claim 13, wherein the sheet comprises poly (vinyl alcohol).

16. A process according to claim 10, comprising the further process steps of:
filling the pocket with a composition,
placing a top film on top of the filled pocket and subsequently sealing the top film to the poly (vinyl alcohol) sheet to form a container containing the composition.

17. A process according to claim 10, wherein the pocket is divided into a plurality of separate portions.

18. A process according to claim 10, wherein the pocket is formed of a material which is soluble in water at a temperature of 20° C.

19. A process according to claim 16, wherein the composition is a liquid or particulate composition.

20. A process according to claim 16, wherein the composition is a fabric care, surface care or dishwashing composition.

21. A mould comprising a pocket, and at least one protrusion or depression on at least one surface and further wherein any protrusion does not extend to or above the upper surface of the mould, wherein the said pocket is thermoformed of a poly(vinyl alcohol) sheet having a thickness of at least 200 μm as a substrate having a reduced tendency to shrink back compared with the same poly(vinyl alcohol) sheet having a lesser thickness.

22. A mould according to claim 21, wherein the pocket contains a fabric care, surface care or dishwashing composition.

23. A mould according to claim 21, wherein the poly(vinyl alcohol) sheet is soluble in water at a temperature of 20° C.
